(19) United States
(12) Patent Application Publication
(10) Pub. No.: US 2003/0176197 A1
(43) Pub. Date: Sep. 18, 2003

(54) Digital enhanced cordless telecommunication handset for integrated data services

(76) Inventors: Che-Hung Chen, Taipei (TW); Chong-Chuan Chuah, Penang (MY); Hai-Boon Tan, Penang (MY)

Correspondence Address: BIRCH STEWART KOLASCH & BIRCH, PO BOX 747, FALLS CHURCH, VA, 22040-0747, US

(21) Appl. No.: 10/095,035

(22) Filed: Mar. 12, 2002

(51) Int. Cl. H04Q 7/20

(52) U.S. Cl. 455/462; 455/465

(57) ABSTRACT

A digital enhanced cordless telecommunication (DECT) handset for integrated data services utilizes the memory of the handset to record image transmission protocols and data transmission protocols, and has an externally connecting mini camera to capture image signals. Through an input module related data can be entered. The DECT handset thus constructed can achieve the object of integrating data services.

### FIELD OF THE INVENTION

The invention relates to a wireless phone, and particularly to a Digital Enhanced Cordless Telecommunication (DECT) handset for integrated data services.

### BACKGROUND OF THE INVENTION

In modem enterprises many employees often have to leave their offices and work outside due to the nature of their jobs, and are away from the telephone communication facilities on the desks in their offices. Cellular phones are expensive, and are thus not applicable to every type of enterprise. Comparatively, Private Automatic Branch Exchange (PABX) and Wireless Local Loop (WLL) are more suitable for such an application.

Generally speaking, cordless telephony means a communication technique in which users utilize a wireless telephone handset to communicate with a fixed processor, which then links to a Public Switch Telephone Network (PSTN) or Private Branch Exchange (PBX). Service targets are limited to people moving in a very small area. Its design is intended for usage different than that of cellular phones installed on vehicles, which are designed to communicate in a relatively wide area.

WLL telephone systems mainly provide wireless telephone operator and extension services for a selected area, such as plant sites, research organizations, school campus, hospital areas, office buildings, and government facilities. People working in the selected area may switch the fixed line extensions on their desks to mobile phones and carry with them to communicate within the area.

In recent years DECT standards have become very popular around the world. DECT standards have many advantages, such as processing digital audio signals with better quality, greater transmission scope, etc., thus they are widely adopted in households and enterprises to communicate in high density areas without interference.

Moreover, in the event that a household uses two DECT handsets and has simultaneous registrations on the DECT base station (one DECT base station can accept simultaneous registrations of six DECT handsets), one DECT handset can be carried outdoors for shopping or even farther away to communicate with another DECT handset. In general, registration is done as follows: for a new DECT handset to register on a base station, the user enters the handset menu and waits for permission signals from the base station to establish handshaking. The base station sends a paging button signal to the DECT handset. Once the confirmation button on the DECT handset is depressed and the confirmation signal is transmitted, the registration procedure at the base station is activated. The whole registration procedure is setup according to standards under DECT protocols of ETS (ETS300175).

Each DECT handset and the base station have an identification (ID) code. During registration, the handset notifies the base station of its ID code. Similarly, the base station also notifies the handset of its ID code. The ID code is the basis for recognition between different DECT handsets. Each base station has a memory space to store as many as six ID codes for DECT handsets.

The DECT handsets can communicate at a longer distance, and handsets registered on the same base station can communicate with one another. How to fully utilize the advantages of DECT handsets with more applications (such as images and data) has become a hotly pursued subject.

### SUMMARY OF THE INVENTION

In view of aforesaid technical problems, the primary object of the invention is to provide a DECT handset for integrated data services within the DECT handset to integrate image transmission and data transmission.

Another object of the invention is to provide a DECT handset with an externally connected mini camera for capturing images for mutual transmission and receiving the images and messages from among a plurality of DECT handsets registered to a DECT base station. Every handset includes an input module for entering messages and control commands; a memory module for storing image communication protocols and data transmission protocols; a radio frequency (RF) module linking to an antenna for receiving and transmitting the images and messages through RF signals; a control unit linking to the mini camera, input module, memory module and RF module to execute control commands, and through the image communication protocols and data transmission protocols stored in the memory module to control the RF module to concert the images and signals to RF signals for transmission and receiving; and a display module linking to the control unit for displaying the images and messages.

In addition, the DECT handset for integrated data services may also integrate the mini camera in the handset to become a handset with a built-in mini camera.

The foregoing, as well as additional objects, features and advantages of the invention will be more readily apparent from the following detailed description, which proceeds with reference to the accompanying drawings. The drawings are only to serve for reference and illustrative purposes, and are not intended to limit the scope of the invention.

### BRIEF DESCRIPTION OF THE DRAWINGS

FIGS. 1A and 1B are schematic views of DECT handsets of the invention;

FIG. 2 is a functional block diagram of a DECT handset and base station according to the invention;

FIG. 3 is a functional block diagram of two DECT handsets according to the invention;

FIG. 4 is a schematic view of a DECT handset of the invention connecting to external accessories;

FIG. 5 is a process flow of the invention for switching DECT the handset mode;

FIG. 6A is a process flow of a DECT handset of the invention for transmitting character messages;

FIG. 6B is a process flow of a DECT handset of the invention for receiving character messages;

FIG. 7A is a process flow of a DECT handset of the invention for transmitting image messages; and

FIG. 7B is a process flow of a DECT handset of the invention for receiving image messages.

### DESCRIPTION OF THE PREFERRED EMBODIMENTS

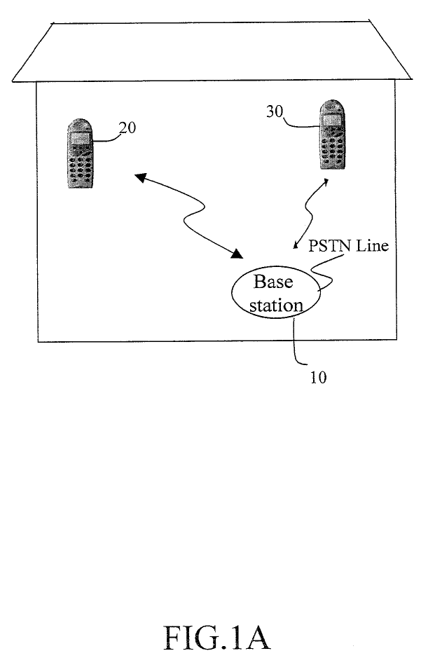

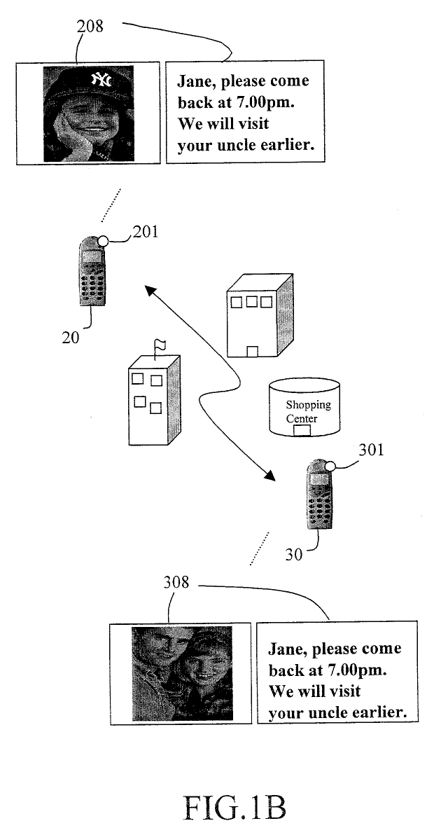

Refer to FIGS. 1A and 1B for the DECT handset of the invention adapted for two-way remote transmission of images and data. As shown in FIG. 1A, when a first DECT handset 20 and a second DECT handset 30 are used in a house, they must process transmission operations through a DECT base station 10. FIG. 1B illustrates the invention utilizing the mutual communication function of the DECT to transmit images and data. Through a built-in first mini camera 201 in the first DECT handset 20 and a built-in second mini camera 301 in the second DECT handset 30, images and data may be displayed on the LCD module. Hence the DECT handset can transmit not only voice, but also images. The mini camera may be a Charge Coupled Device (CCD) or other desired image capturing device.

As DECT handsets can communicate with one another only after having registered to a base station (maximum six handsets), the image and data transmission mode of the invention is called personal radio mode.

When utilizing the personal radio mode of the invention, which requires switching the original DECT handset from handset mode to DECT personal radio mode (as shown in FIGS. 1A and 1B), the DECT handsets may process mutual communication without involving the base station. This may be accomplished because the base station has stored the ID codes of the original handsets. When operating in personal radio mode, the base station transmits the ID codes of the DECT handsets, linking every DECT handset in personal radio mode. By means of such an exchange, the DECT handsets under the same base station system can communicate with one another without going through the base station.

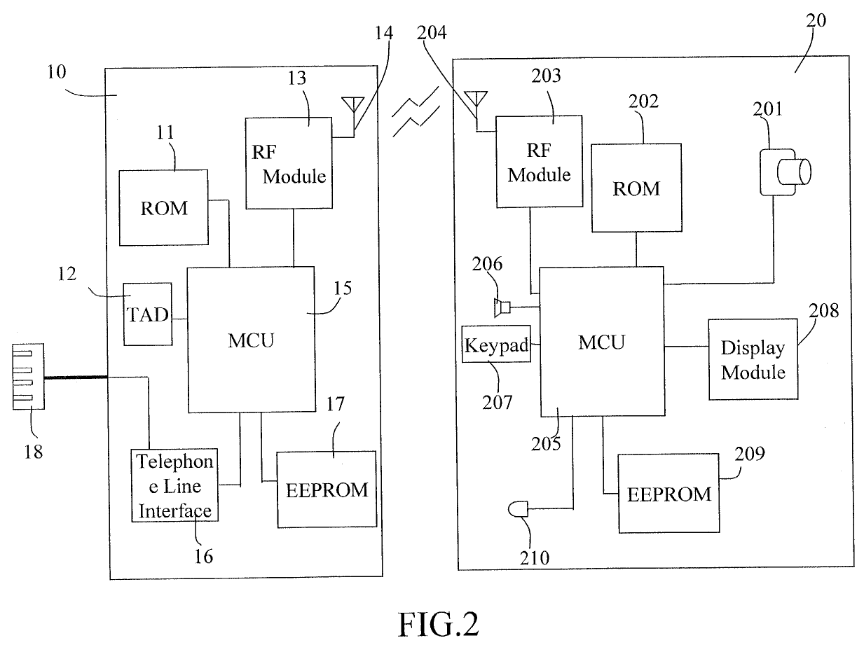

When switching the DECT handset from voice transmission mode to image and data transmission mode, a structural adjustment must be made on the DECT handset. Refer to FIG. 2 for a functional block diagram of the base station 10 and the first DECT handset 20. As shown in the drawing, the base station 10 includes a first Read Only Memory (ROM) 11, a Telephone Answering Device (TAD) 12, a first RF module 13, a first antenna 14, a first microprocessor 15, a telephone line interface 16, a first Erasable Read Only Memory (EEPROM) 17 and a Public Switch Telephone Network (PSTN) 18. The first DECT handset 20 consists of a mini camera 201, a second ROM 202, a second RF module 203, a second antenna 204, a second microprocessor 205, a speaker 206, a keypad 207, a second display module 208, a second EEPROM 209 and a microphone 210.

The first RF module 13 and the first antenna 14 of the base station 10 transmit radio signals. The first microprocessor 15 reads program codes stored in the first ROM 11 and first EEPROM 17 to control the telephone line interface 16 in order to communicate with external lines through the PSTN 18, controls the first RF module and the first antenna 14 to transmit radio signals, and controls the TAD 12 to perform telephone answering operations. Through the first RF module 13 and the first antenna 14, the base station 10 and the first DECT handset 20 may communicate with each other. On the other hand, the first DECT handset 20 may communicate with the base station 10 through its own second RF module 203 and second antenna 204. The base station 10 and the first DECT handset 20 maintain a wireless linking relationship. Through communication of the RF modules, the base station 10 becomes the agent of the first DECT handset 20, and through the PSTN 18 communicates externally in a wired mode. The first ROM 11 records related protocols for voice transmission. The first EEPROM 17 records registered ID codes of various DECT handsets.

The elements in the first DECT handset 20 are generally like the ones contained in the base station 10. The main differences are: the second display module 208 includes a display device and a display device driver module for displaying related data and information. The keypad 207 allows users to enter related data; the speaker 206 broadcasts audio signals. The microphone 210 receives a user's voice and transmits voice signals. The mini camera 201 built-into the DECT handset allows the DECT handset to capture image data.

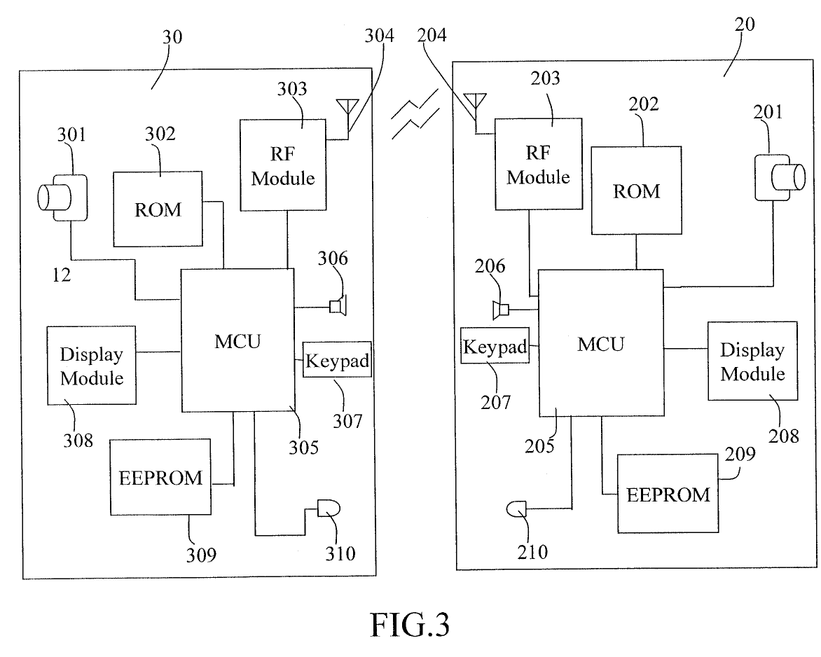

In order to enable the DECT handset to actually transmit images and data, related communication protocols must be recorded in the ROM. FIG. 3 illustrates a method for accomplishing this end.

As shown in FIG. 3, the first DECT handset 20 and the second DECT handset 30 have similar functional block diagrams, and have similar structural elements. They are respectively a mini camera 301, a third ROM 302, a third RF module 303, a third antenna 304, a third microprocessor 305, a third speaker 306, a third keypad 307, a third display module 308, a third EEPROM 309 and a third microphone 310.

Hence, after the second ROM 202 and the third ROM 302 are properly altered (all DECT handsets used in the invention must be altered) to include communication protocols for image and data transmission, the DECT handsets of the invention may be used to transmit signals among one another. After including the related communication protocols, operation procedures of the handsets also are changed.

On the other hand, the original EEPROMs 209, 309 on the DECT handsets may also be used to perform additional tasks related to the communication protocols. In this case, there is no need to change the original DECT handsets, and the DECT handsets can be directly used for image and data transmission.

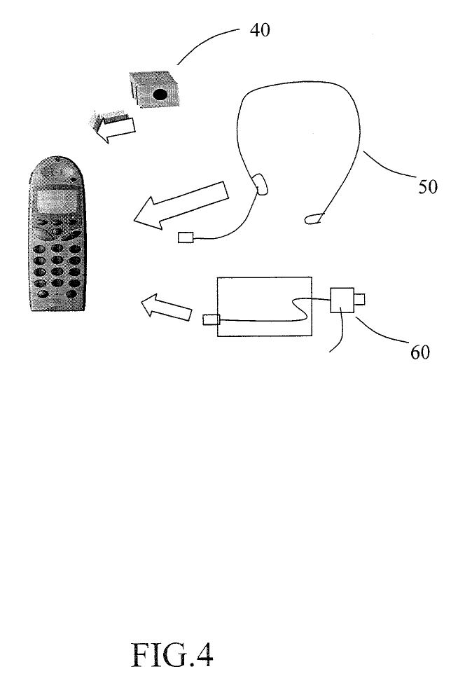

FIG. 4 illustrates external connection accessories of the DECT handset of the invention. To achieve the object of utilizing an original DECT handset to transmit images and data, the mini camera 40 may be externally connected, and the EEPROM must be altered. In addition, the DECT handset may be connected to a headphone 50, a charger 60 or the like.

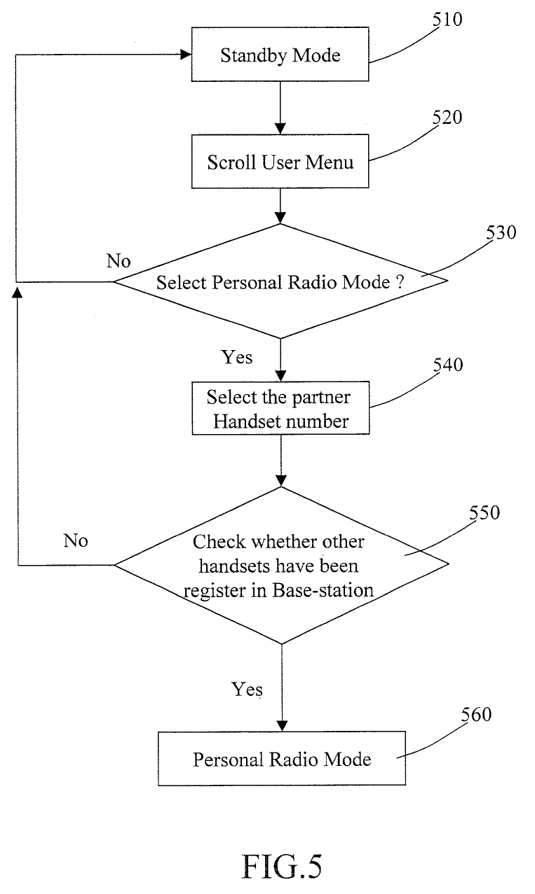

Refer to FIGS. 5, 6 and 7 for the image transmission and data transmission method of the invention. The processes may be recorded in the ROM or EEPROM. The major data and image transmission processes are elaborated as follows:

FIG. 5 shows the processes of switching a DECT handset from handset mode to personal radio mode to allow DECT handsets registered on the same base station to perform data services. Detailed processes are as follows:

First, the system is in a standby mode (step 510). Once the handset is activated, a user may scroll user menu (step 520) for selection. Many selection items are presented on the menu for users to choose, one of them is personal radio mode. If the user select personal radio mode (step 530), the system enter next selection menu, i.e. select the partner handset numbers (step 540). The DECT base station may register six DECT handset numbers and transmits signals to every handset, hence once the user selects personal radio mode and the matching handset numbers, the handset transmits signals to the base station, which checks whether the selected matching handsets have been registered (step 550). For example, check whether the selected matching handsets have been registered. If the matching handsets are registered on the base station, enter personal radio mode (step 560).

On the other hand, at step 530, in the event that the user does not select personal radio mode, the handset will return to the standby mode (step 510). At step 550, if the handset checks registrations on base station, and detects that the selected matching handsets are not registered, the handset also returns to the standby mode (step 510).

First, in personal radio mode (step 560), the handset has many selections, such as data transmission mode or image transmission mode. A user can select transmission mode from the menu and process data transmission or image transmission.

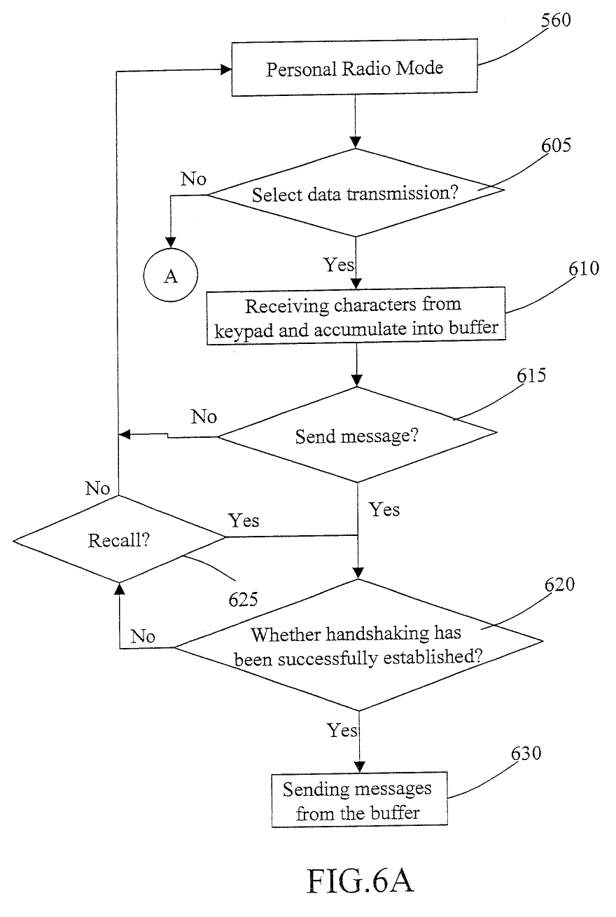

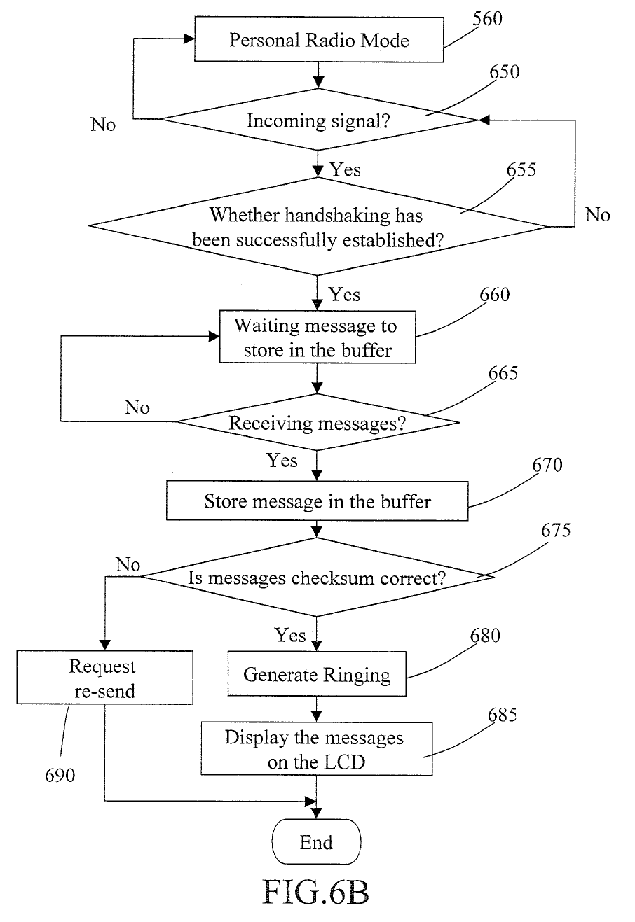

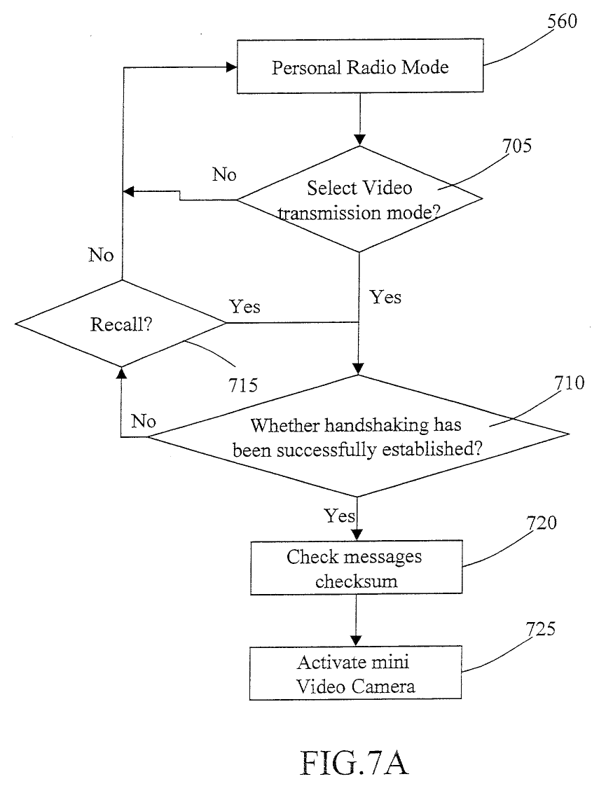

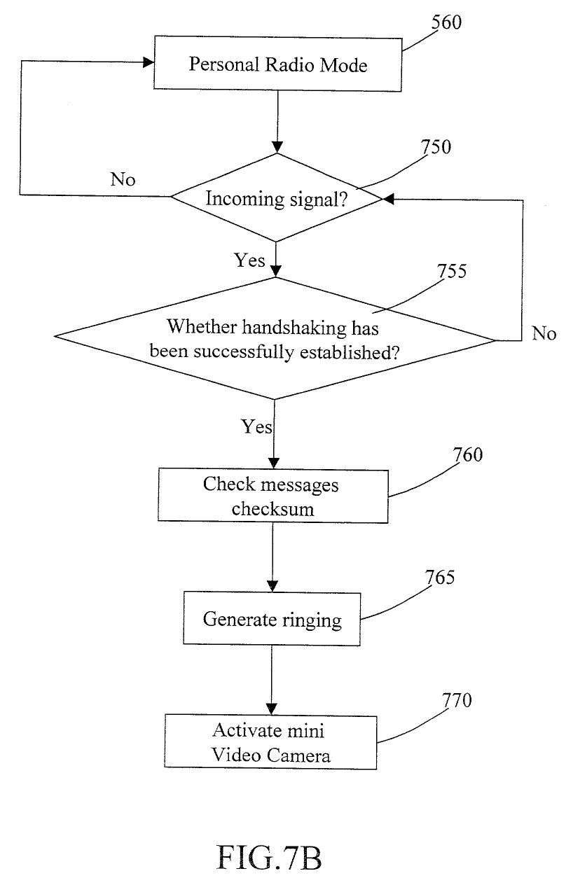

FIGS. 6A and 6B illustrate process flows for data transmission, and FIGS. 7A and 7B illustrate process flows for image transmission.

Refer to FIG. 6A for the processes of a DECT handset of the invention transmitting character messages. In personal radio mode (step 560), an user decides the selection item to be chosen. Once the user selects data transmission mode, i.e. step 605, the firmware of the handset detects whether a matching communication partner being set is found. If the user does not select data transmission mode, the handset remains in the personal radio mode (step 560). The firmware processing depends on the communication partner's data entered by the user via a keypad. The process is that data are received from the keypad and stored in an buffer shown in step 610. Once the user and the matching partner have established handshaking, data stored in the buffer may be transmitted. At this stage, step 615 may be added, i.e. ask user if there are messages to be transmitted. If the outcome is positive, process handshaking. If the outcome is negative, return to personal radio mode (step 560). At step 620, if the partner's handset is found, handshaking is successfully established, and the messages may be transmitted immediately, i.e. messages are retrieved from the buffer and transmitted (step 630). In other words, once two DECT handsets have established handshaking, both handsets transmit signals to the other party to indicate that there are messages to be transmitted or received, and the messages stored in the buffer are transmitted through the RF module.

In the event that the matching partner's handset is not found, ask the user whether s/he would like to recall (step 625). If the user chooses to repeat the broadcasting, the processes for handshaking are continuously executed, and this step is repeatedly performed until handshaking with the matching partner's handset has been established. If the user chooses not to repeat the broadcasting, the handset returns to personal radio mode selection items, i.e. returns to step 560.

Refer to FIG. 6B for the processes of the DECT handset at the receiving end to constantly check whether there is an incoming call, i.e. the step 650. Once an incoming signal is detected, the handset checks to determine whether handshaking has been successfully established (step 655), i.e. whether handshaking with the calling party has been successfully established. Then handset waiting messages are stored in the buffer (step 660), and repeatedly check to determine whether the system is receiving messages (step 665). Once messages are received, they are stored in the buffer (step 670). After receiving messages, the handset verifies whether the checksum is correct (step 675) to avoid producing error messages. Once they are verified as correct, generate ringing (step 680), and display the messages on the LCD module (step 685) to notify user of the incoming messages. If the inspection code is wrong, send out a message to request re-send (step 690).

Any handset is in transmission mode or receiving mode. When the handset is in transmission mode, the processes shown in FIG. 6A are applied. When the handset is in receiving mode, the processes shown in FIG. 6B are applied. The processes are repeatedly performed depending on handset conditions.

FIGS. 7A and 7B illustrate image transmission processes. Refer to FIG. 7A for the DECT handset of the invention during image transmission processes. First, in personal radio mode (step 560), a user decides the selection item to be chosen, once the user selects image transmission mode, i.e. step 705, whether or not to select image transmission mode (step 705). If the image transmission mode is not selected, the user may choose other options in the personal radio mode (step 560). Once select the image transmission mode, then process handshaking with the partner's handset and determine whether handshaking has been successfully established (step 710). Once handshaking has been established, check messages checksum (step 720). Then activates the mini video camera and prepare image transmission (step 725) to prepare image transmission. On the other hand, if handshaking has not been established, ask the user whether or not broadcasting should recall (step 715). If recalling is confirmed, repeat broadcasting until handshaking is established. If recalling is denied, return to personal radio mode (step 560) menu.

Image transmission mode is like data transmission mode; in addition to image transmission processes, there are also image receiving processes. Refer to FIG. 7B for the image receiving processes. First, the DECT handset at the receiving end constantly checks to determine whether there is incoming call, i.e. step 750. Once incoming signals have been received, the handset checks whether handshaking has been established (step 755), i.e. checks whether handshaking with the calling party has been successfully established. Then the handset checks messages checksum (step 760), and generates ringing (step 765). Then activate the mini video camera (step 770) which may be operated by the user to process image transmission operations, i.e. execute the transmission processes shown in FIG. 7A.

All the messages are selectively characters or numerals.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A digital enhanced cordless telecommunication (DECT) handset for integrated data services externally connecting a mini camera for capturing images and communicating with a plurality of DECT handsets which have registered to a DECT base station to transmit and receive the images and messages among the DECT handsets, each DECT handset comprising:
an input module for inputting the messages and control commands;
a memory module for storing image communication protocols and data transmission protocols;
a radio frequency (RF) module connected to an antenna for receiving and transmitting the images and the messages through RF signals;
a control unit connected to the mini camera, the input module, the memory module and the RF module to execute the control commands, and according to the image communication protocols and the data transmission protocols stored in the memory module to control the RF module to transform the images and the messages into the RF signals for transmission and receiving; and
a display module connected to the control unit for displaying the images and the messages.

2. The digital enhanced cordless telecommunication (DECT) handset for integrated data services of claim 1, wherein the messages are selected from the group consisted of characters and numerals.

3. The digital enhanced cordless telecommunication (DECT) handset for integrated data services of claim 1, wherein the input module is a keypad.

4. The digital enhanced cordless telecommunication (DECT) handset for integrated data services of claim 1, wherein the memory module includes a read only memory (ROM) and an erasable read only memory (EEPROM).

5. The digital enhanced cordless telecommunication (DECT) handset for integrated data services of claim 1, wherein the display module includes a display device and a display device driver module.

6. The digital enhanced cordless telecommunication (DECT) handset for integrated data services of claim 1, wherein the control unit is a microprocessor.

7. A digital enhanced cordless telecommunication (DECT) handset for integrated data services for communicating with a plurality of DECT handsets which have registered to a DECT base station to transmit and receive images and messages among the DECT handsets, each DECT handset comprising:
an image capturing unit for capturing the images;
an input module for entering the messages and control commands;
a memory module for storing image communication protocols and data transmission protocols;
a radio frequency (RF) module connected to an antenna for receiving and transmitting the images and the messages through RF signals;
a control unit connected to a mini camera, the input module, the memory module and the RF module to execute the control commands, and according to the image communication protocols and the data transmission protocols stored in the memory module to control the RF module to transform the images and the messages into the RF signals for transmission and receiving; and
a display module connected to the control unit for displaying the images and the messages.

8. The digital enhanced cordless telecommunication (DECT) handset for integrated data services of claim 7, wherein the image capturing unit is a charge coupled device (CCD).

9. The digital enhanced cordless telecommunication (DECT) handset for integrated data services of claim 7, wherein the messages is selected from the group consisted of characters and numerals.

10. The digital enhanced cordless telecommunication (DECT) handset for integrated data services of claim 7, wherein the input module is a keypad.

11. The digital enhanced cordless telecommunication (DECT) handset for integrated data services of claim 7, wherein the memory module includes a read only memory (ROM) and an erasable read only memory (EEPROM).

12. The digital enhanced cordless telecommunication (DECT) handset for integrated data services of claim 7, wherein the display module includes a display device and a display device driver module.

13. The digital enhanced cordless telecommunication (DECT) handset for integrated data services of claim 7, wherein the control unit is a microprocessor.
